(19) United States
(12) Patent Application Publication
(10) Pub. No.: US 2024/0428006 A1
(43) Pub. Date: Dec. 26, 2024

(54) LARGE LANGUAGE MODEL (LLM) QUANTIZATION

(71) Applicant: GOOGLE LLC, Mountain View, CA (US)

(72) Inventors: Jian Li, Mountain View, CA (US); Zhifeng Chen, Sunnyvale, CA (US); Yanping Huang, Mountain View, CA (US); Yuanzhong Xu, Mountain View, CA (US); Tao Wang, Sunnyvale, CA (US); YaGuang Li, Sunnyvale, CA (US)

(21) Appl. No.: 18/211,967

(22) Filed: Jun. 20, 2023

(51) Int. Cl. G06F 40/40

(52) U.S. Cl. CPC G06F 40/40

(57) ABSTRACT

Implementations relate to asymmetric quantization of large language models (LLMs). Processor(s) of a system can: obtain a trained LLM, wherein the trained LLM includes a plurality of layers, each layer comprising a respective plurality of weights; for each layer of the plurality of layers: calculate an optimal clipping range for the respective plurality of weights, and clip one or more weights of the respective plurality of weights that lie outside of the optimal clipping range to produce a clipped layer; quantize the LLM to generate a quantized LLM, wherein the instructions to quantize include instructions to map weights of the plurality of clipped layers of the LLM from continuous values to discrete values; and provide the quantized LLM for downstream processing.

### BACKGROUND

Large language models (LLMs) are particular types of machine learning models that can perform various natural language processing (NLP) tasks, such as language generation, machine translation, and question-answering. These LLMs are typically trained on enormous amounts of diverse data including data from, but not limited to, webpages, electronic books, software code, electronic news articles, and machine translation data. Accordingly, these LLMs leverage the underlying data on which they were trained in performing these various NLP tasks. For instance, in performing a language generation task, these LLMs can process a natural language (NL) based input that is received from a client device, and generate a NL based output that is responsive to the NL based input and that is to be rendered at the client device.

LLMs often include enormous numbers (e.g., billions) of parameters. As a consequence, LLMs tend to be costly—computationally, latency-wise, and/or in terms of maintenance—to train and apply. For example, in generating NL based output utilizing these LLMs, additional latency is introduced that may not be present absent utilizing these LLMs. This additional latency can prolong user interactions with these LLMs and detract from a user experience with these LLMs. Accordingly, there is a need in the art for reducing latency in utilizing these LLMs.

One technique that can be used to reduce the latency and/or computational costs is quantization. Quantization is the process of mapping continuous values to discrete values. In the context of LLMs, parameters such as weights or activations that are initially represented by/trained using continuous variables, such as float or double, can be mapped instead to discrete variables such as integers, effectively reducing bit precision. One challenge of quantization is dealing with parameter outliers that may or may not significantly influence inferences and predictions generated using LLMs.

### SUMMARY

Implementations described herein relate to quantizing LLMs using optimized weight clipping on asymmetric weights. In various implementations, an LLM may be initialized (e.g., from scratch, bootstrapped using transfer learning, etc.) with floating point or other high-bit-precision data types. The LLM may then be trained using any number of corpuses of data. While the trained LLM may be usable to generate highly accurate inferences, the high-bit-precision data used for its weights may result in high latency. Loading the LLM in memory that is accessible to one or more graphical processing units (GPUs) or tensor processing units (TPUs) may be particularly time consuming.

With implementations described herein, weights of multiple individual layers of the LLM may clipped separately, e.g., to remove outlier weights with minimal impact on accuracy of the LLM. For example, an optimal clipping range may be calculated for a plurality of weights that forms a particular layer, e.g., using greedy search based on max-absolute error. Calculating the optimal clipping range as described herein may balance resolution errors and clipping errors. The optimal clipping range may then be used to clip one or more weights of the plurality of weights forming the layer that lie outside of the optical clipping range. The result may be a clipped layer.

After clipping multiple layers of the LLM in this fashion, the LLM may be quantized to generate a quantized LLM. Put another way, float (or similar) values of the unquantized LLM may be mapped to integer values in a range of integer values. For example, where individual weights of the unquantized LLM may be represented by floating point values (each having 32 or even 64 bits), individual weights of the quantized LLM may be represented with lower bit-precision values, such as 8-bit integers. With techniques described herein, the quantization may be performed asymmetrically by pre-calculating the zero-point—that is, the unquantized weight value that should map to the zero-integer value—offline, e.g., on a layer-by-layer basis.

In some implementations, a method may be implemented using one or more processors and may include: obtaining a trained large language model (LLM), wherein the trained LLM includes a plurality of layers, each layer comprising a respective plurality of weights; for each layer of the plurality of layers: calculating an optimal clipping range for the respective plurality of weights, and clipping one or more weights of the respective plurality of weights that lie outside of the optimal clipping range to produce a clipped layer; quantizing the LLM to generate a quantized LLM, wherein the quantizing includes mapping weights of the plurality of clipped layers of the LLM from continuous values to discrete values; and providing the quantized LLM for downstream processing.

In various implementations, the calculating may be performed using greedy search. In various implementations, the optimal clipping range may be calculated based on a max-absolute-error. In various implementations, the optimal clipping range may be calculated to balance resolution errors and clipping errors of the LLM.

In various implementations, the LLM may be a transformer model. In various implementations, the quantizing may include asymmetric weight quantization. In various implementations, the asymmetric quantization may include pre-calculation of a zero point.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts an example process flow for asymmetrically quantizing LLM weights layer-by-layer, in accordance with various implementations.

FIG. 3 depicts a flowchart illustrating an example method of practicing selected aspects of the present disclosure, in accordance with various implementations.

FIG. 4 depicts an example architecture of a computing device, in accordance with various implementations.

### DETAILED DESCRIPTION OF THE DRAWINGS

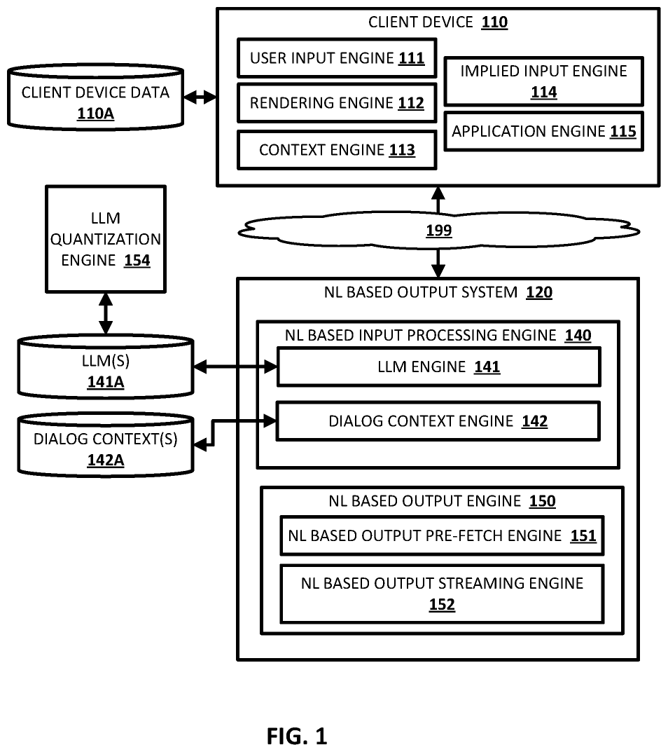

Turning now to FIG. 1, a block diagram of an example environment that demonstrates various aspects of the present disclosure, and in which implementations disclosed herein can be implemented is depicted. The example environment includes a client device 110 and a natural language (NL) based output system 120. While system 120 is described herein as NL-based, that does not limit techniques described herein to quantizing NL-based LLMs. LLMs configured to process any number of input modalities, such as NL, images, sounds/voice, and so forth, may be quantized using techniques described herein.

In some implementations, all or aspects of the NL based output system 120 can be implemented locally at the client device 110. In additional or alternative implementations, all or aspects of the NL based output system 120 can be implemented remotely from the client device 110 as depicted in FIG. 1 (e.g., at remote server(s)). In those implementations, the client device 110 and the NL based output system 120 can be communicatively coupled with each other via one or more networks 199, such as one or more wired or wireless local area networks (“LANs,” including Wi-Fi, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications, via application engine 115, through which NL based input can be submitted and/or NL based output and/or other output that is responsive to the NL based input can be rendered (e.g., audibly and/or visually). The application engine 115 can execute one or more software applications that are separate from an operating system of the client device 110 (e.g., one installed “on top” of the operating system)—or can alternatively be implemented directly by the operating system of the client device 110. For example, the application engine 115 can execute a web browser or automated assistant installed on top of the operating system of the client device 110. As another example, the application engine 115 can execute a web browser software application or automated assistant software application that is integrated as part of the operating system of the client device 110. The application engine 115 (and the one or more software applications executed by the application engine 115) can interact with the NL based output system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110.

Some instances of a NL based input described herein can be a query for a NL response that is formulated based on user input provided by a user of the client device 110 and detected via user input engine 111. For example, the query can be a typed query that is typed via a physical or virtual keyboard, a suggested query that is selected via a touch screen or a mouse of the client device 110, a spoken voice query that is detected via microphone(s) of the client device 110 (and optionally directed to an automated assistant executing at least in part at the client device 110), or an image or video query that is based on vision data captured by vision component(s) of the client device 110 (or based on NL input generated based on processing the image using, for example, object detection model(s), captioning model(s), etc.). Other instances of a NL based input described herein can be a prompt for NL content that is formulated based on user input provided by a user of the client device 110 and detected via the user input engine 111. For example, the prompt can be a typed prompt that is typed via a physical or virtual keyboard, a suggested prompt that is selected via a touch screen or a mouse of the client device 110, a spoken prompt that is detected via microphone(s) of the client device 110, or an image prompt that is based on an image captured by a vision component of the client device 110.

In various implementations, the client device 110 can include a rendering engine 112 that is configured to render content (e.g., NL based output, an indication of source(s) associated with the NL based output, and/or other content) for audible and/or visual presentation to a user of the client device 110 using one or more user interface output devices. For example, the client device 110 can be equipped with one or more speakers that enable the content to be provided for audible presentation to the user via the client device 110. Additionally, or alternatively, the client device 110 can be equipped with a display or projector that enables the content to be provided for visual presentation to the user via the client device 110.

In various implementations, the client device 110 can include a context engine 113 that is configured to determine a context (e.g., current or recent context) of the client device 110 and/or of a user of the client device 110 (e.g., an active user of the client device 110 when the client device 110 is associated with multiple users). In some of those implementations, the context engine 113 can determine a context based on data stored in client device data database 110A. The data stored in the client device data database 110A can include, for example, user interaction data that characterizes current or recent interaction(s) of the client device 110 and/or a user of the client device 110, location data that characterizes a current or recent location(s) of the client device 110 and/or a user of the client device 110, user attribute data that characterizes one or more attributes of a user of the client device 110, user preference data that characterizes one or more preferences of a user of the client device 110, user profile data that characterizes a profile of a user of the client device 110, and/or any other data accessible to the context engine 113 via the client device data database 110A or otherwise.

For example, the context engine 113 can determine a current context based on a current state of a dialog session (e.g., considering one or more recent inputs provided by a user during the dialog session), profile data, and/or a current location of the client device 110. For instance, the context engine 113 can determine a current context of “visitor looking for upcoming events in Louisville, Kentucky” based on a recently issued query, profile data, and an anticipated future location of the client device 110 (e.g., based on recently booked hotel accommodations). As another example, the context engine 113 can determine a current context based on which software application is active in the foreground of the client device 110, a current or recent state of the active software application, and/or content currently or recently rendered by the active software application. A context determined by the context engine 113 can be utilized, for example, in supplementing or rewriting NL based input that is formulated based on user input, in generating an implied NL based input (e.g., an implied query or prompt formulated independent of any explicit NL based input provided by a user of the client device 110), and/or in determining to submit an implied NL based input and/or to render result(s) (e.g., an NL based output) for an implied NL based input.

In various implementations, the client device 110 can include an implied input engine 114 that is configured to: generate an implied NL based input independent of any user explicit NL based input provided by a user of the client device 110; submit an implied NL based input, optionally independent of any user explicit NL based input that requests submission of the implied NL based input; and/or cause rendering of search result(s) or a NL based output for the implied NL based input, optionally independent of any explicit NL based input that requests rendering of the search result(s) or the NL based output. For example, the implied input engine 114 can use one or more past or current contexts, from the context engine 113, in generating an implied NL based input, determining to submit the implied NL based input, and/or in determining to cause rendering of search result(s) or a NL based output that is responsive to the implied NL based input. For instance, the implied input engine 114 can automatically generate and automatically submit an implied query or implied prompt based on the one or more past or current contexts. Further, the implied input engine 114 can automatically push the search result(s) or the NL based output that is generated responsive to the implied query or implied prompt to cause them to be automatically rendered or can automatically push a notification of the search result(s) or the NL based output, such as a selectable notification that, when selected, causes rendering of the search result(s) or the NL based output. Additionally, or alternatively, the implied input engine 114 can submit respective implied NL based input at regular or non-regular intervals, and cause respective search result(s) or respective NL based outputs to be automatically provided (or a notification thereof automatically provided). For instance, the implied NL based input can be “patent news” based on the one or more past or current contexts indicating a user's general interest in patents, the implied NL based input or a variation thereof periodically submitted, and the respective search result(s) or the respective NL based outputs can be automatically provided (or a notification thereof automatically provided). It is noted that the respective search result(s) or the respective NL based output can vary over time in view of, e.g., presence of new/fresh search result document(s) over time.

Further, the client device 110 and/or the NL based output system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household, a workplace, a hotel, etc.).

The NL based output system 120 is illustrated in FIG. 1 as including a NL based input processing engine 140 and a NL based output engine 150. Some of these engines can be combined and/or omitted in various implementations. Further, these engines can include various sub-engines. For instance, the NL based input processing engine 140 is illustrated in FIG. 1 as including a LLM engine 141 and a dialog context engine 142. Moreover, the NL based output engine 150 is illustrated in FIG. 1 as including a NL based output pre-fetch engine 151 and a NL based output streaming engine 152. Similarly, some of these sub-engines can be combined and/or omitted in various implementations. Accordingly, it should be understood that the various engines and sub-engines of the NL based output system 120 illustrated in FIG. 1 are depicted for the sake of describing certain functionalities and are not meant to be limiting.

Further, the NL based output system 120 is illustrated in FIG. 1 as interfacing with various databases, such as LLM(s) database 141A and dialog context(s) database 142A. Although particular engines and/or sub-engines are depicted as having access to particular databases, it should be understood that is for the sake of example and is not meant to be limiting. For instance, in some implementations, each of the various engines and/or sub-engines of the NL based output system 120 may have access to each of the various databases. Further, some of these databases can be combined and/or omitted in various implementations. Accordingly, it should be understood that the various databases interfacing with the NL based output system 120 illustrated in FIG. 1 are depicted for the sake of describing certain data that is accessible to the NL based output system 120 and is not meant to be limiting.

In various implementations, NL based output system 120 can cause the LLM engine 141 to process, using a LLM stored in the LLM(s) database 141A, NL based input to generate a stream of LLM output. The LLM can include, for example, any LLM that is stored in the LLM(s) database 141A, such as PaLM, BARD, BERT, LaMDA, Meena, GPT, and/or any other LLM, such as any other LLM that is encoder-only based, decoder-only based, sequence-to-sequence based and that optionally includes an attention mechanism or other memory. The stream of LLM output can include, for example, a probability distribution over a sequence of tokens, such as words, phrases, or other semantic units, that are predicted to be responsive to the NL based input. Notably, the LLM can include billions of weights and/or parameters that are learned through training the LLM on enormous amounts of diverse data. This enables the LLM to generate the LLM output as the probability distribution over the sequence of tokens. In various implementations, NL based output system 120 may cause dialog context engine 142 to manage dialog contexts based on data stored in dialog context database 142A, including identifying new dialog contexts, shifting between existing dialog contexts, etc.

As noted previously, LLMs often have enormous numbers of parameters such as weights, neurons (including activation functions), etc. Representing these data with high-bit-precision data types such as doubles of floats can result in high computational cost and latency. Quantization can be applied to convert various LLM parameters to lower bit-precision types of data, such as 8-bit integers. One challenge of quantization is dealing with outliers. Some techniques for dealing with outliers include clipping outliers from input data during inference and clipping activation functions, e.g., inside of neurons. For a variety of reasons, however, outlier weights have not historically been clipped as part of quantization. Asymmetric quantization can be prohibitively expensive when the zero point is calculated in real time/during inference.

In various implementations, an LLM quantization engine 154 may be configured with selected aspects of the present disclosure in order to generate quantized LLMs from non-quantized LLMs 141A while overcoming various challenges described previously. In various implementations, LLM quantization engine 154 may be configured to obtain, e.g., from database 141A, a trained LLM that includes a plurality of layers, each layer including a respective plurality of weights (as well as neurons/activations in many cases).

For each layer of the plurality of layers, LLM quantization engine 154 may be configured to calculate an optimal clipping range for the respective plurality of weights of the layer. In some implementations, LLM quantization engine 154 may calculate the optimal clipping range using greedy searching, e.g., based on a max-absolute-error. In other implementations, mean-absolute-error or mean-square error may be used; however, max-absolute-error may be more indicative of quantization quality because a large deviation at a single location, which may be best measured using max-absolute-error, may be more disruptive than, for instance, a more uniformly distributed deviation for the overall quality of quantization. In some implementations, LLM quantization engine 154 may calculate the optimal clipping range to balance resolution errors and clipping errors of the LLM.

Once the optimal clipping range for the current layer is calculated, LLM quantization engine 154 may clip one or more weights of the respective plurality of weights that lie outside of the optimal clipping range to produce a clipped layer. For example, weights that are greater than the optimal clipping range may be rounded down to a maximum weight value of the optimal clipping range. Likewise, weights that are less than the optimal clipping range may be rounded up to a minimum weight value of the optimal clipping range. Additionally or alternatively, during quantization, weights that are greater than the optimal clipping range may be mapped to a maximum discrete value of a range of discrete values to which the layer's continuous weights are mapped. Likewise, weights that are less than the optimal clipping range may be mapped to a minimum discrete value of the range of discrete values to which the layer's continuous weights are mapped.

As alluded to above, LLM quantization engine 154 may quantize the LLM to generate a quantized LLM. This quantizing may include mapping weights of the plurality of clipped layers of the LLM from continuous values to discrete values. Parameters of the resulting quantized LLM may be represented with lower bit-precision values such as 8-bit integers. As a consequence, applying the quantized LLM during downstream processing may result in a significantly lower latency than application of the unquantized LLM (e.g., with continuous weights), without significant loss of accuracy.

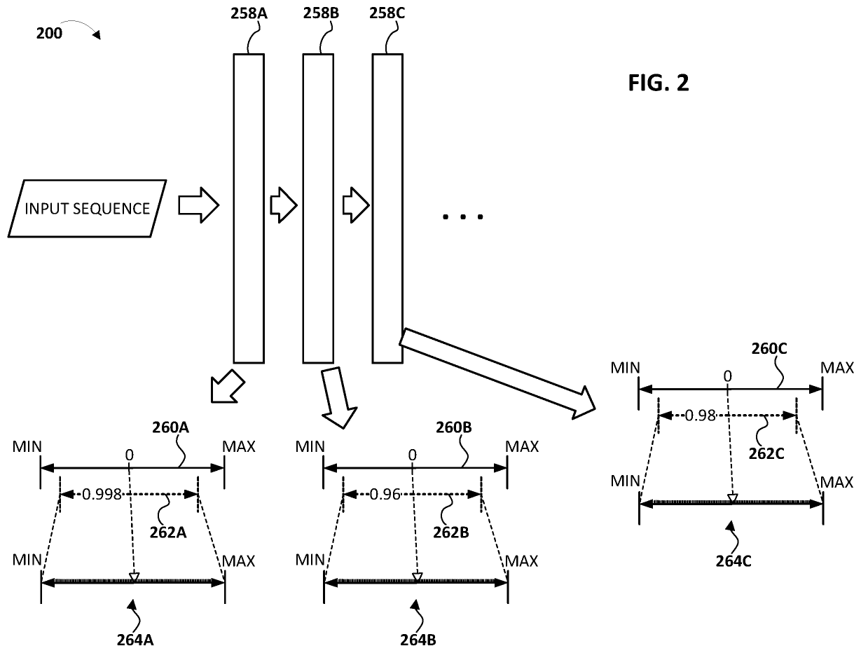

FIG. 2 schematically depicts an example of how techniques described herein may be implemented to quantize an LLM 200, in accordance with various implementations. LLM 200 is depicted in FIG. 2 as including some number of layers 258A, 258B, 258C . . . that are arranged in sequence. These layers may represent and/or correspond to layers of any LLM that is stored in the LLM(s) database 141A, such as PaLM, BARD, BERT, LaMDA, Meena, GPT, and/or any other LLM, such as any other LLM that is encoder-only based, decoder-only based, sequence-to-sequence based and that optionally includes an attention mechanism or other memory.

Each layer 258 may be processed, e.g., by LLM quantization engine 154 (not depicted in FIG. 2, see FIG. 1), in order to generate a quantized layer. As indicated by the arrows pointing downwards, for each layer 258, this quantization may include determining a range 260 of continuous weight values that are contained in the layer. Then, LLM quantization engine 154 may calculate an optimal clipping range 262. In FIG. 2, for instance, the optimal clipping range 262A for the first layer 258A is 0.998 of the entire range 260A of continuous weight values of the first layer 258A. The optimal clipping range 262B for the second layer 258B is 0.96 of the entire range 260B of continuous weight values of the second layer 258B. And the optimal clipping range 262C for the third layer 258C is 0.98 of the entire range 260C of continuous weight values of the third layer 258C.

Next, continuous weight values from within the optimal clipping range 262 of the entire range 260 of continuous weight values may be mapped to a quantized range 264 of discrete weight values (as illustrated by the grid lines on range 264). In FIG. 2, for instance, continuous weight values of first range 260A of continuous weight values of first layer 258A that lie within first optimal clipping range 262A are mapped to a first quantized range 264A of discrete weight values. Continuous weight values of second range 260B of continuous weight values of second layer 258B that lie within second optimal clipping range 262B are mapped to a second quantized range 264B of discrete weight values. And continuous weight values of third range 260C of continuous weight values of third layer 258C that lie within third optimal clipping range 262C are mapped to a third quantized range 264C of discrete weight values. The result is a quantized LLM with layers that each include discrete weight values.

Also depicted in FIG. 2 by arrows with white tips are a precalculated zero-points of asymmetric weight quantization, which map from the ranges 260A-C of continuous values to particular discrete values of the quantized ranges 264A-C of discrete weight values.

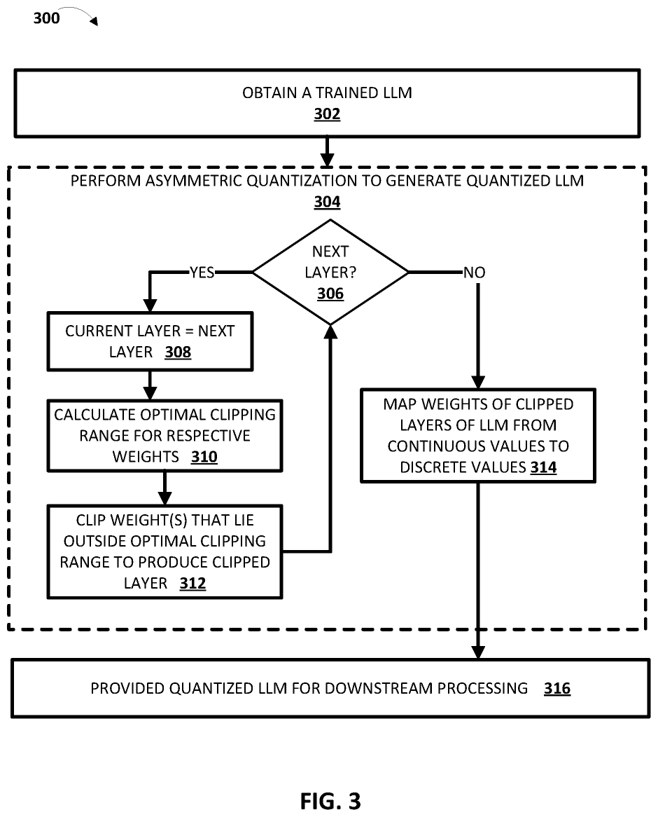

Turning now to FIG. 3, a flowchart illustrating an example method 300 of practicing selected aspects of the present disclosure. For convenience, the operations of the method 300 are described with reference to a system that performs the operations. This system may include one or more processors, memory, and/or other component(s) of computing device(s). Moreover, while operations of the method 300 are shown in a particular order, this is not meant to be limiting. One or more operations may be reordered, omitted, and/or added.

At block 302, the system, e.g., by way of LLM quantization engine 154 or LLM engine 141, may obtain a trained LLM. In various implementations, and as illustrated in FIG. 2, the trained LLM may include a plurality of layers. Each layer may include a respective plurality of weights, as well as other parameters such as neurons/activation functions.

At block 304, the system may perform asymmetric quantization of the LLM to generate a quantized LLM. For instance, at block 306, the system may determine whether there are more layers of the LLM to clip. If the answer at block 306 is yes, then at block 308, the next layer is made the current layer.

At block 310, an optimal clipping range is calculated for the current layer. This may be performed using techniques such as greedy searching and/or maximum absolute error. Based on the optimal clipping range calculated at block 310, at block 312, the system may clip weights of the current layer that lie outside of the optimal clipping range. For example, these weights may be discarded, rounded up down, etc.

Blocks 306-312 may continue until it is determined at block 306 that there are no more layers of the LLM to clip. Method 300 may then proceed to block 314, where LLM quantization engine 154 may quantize the LLM by mapping weights of the plurality of clipped layers of the LLM from continuous values to discrete values. The mapped discrete values may be used, e.g., as “bins” for ranges of continuous values.

At block 316, the system may provide the quantized LLM for downstream processing. For example, LLM quantization engine 154 may store the quantized LLM in database 141A. Subsequently, NL based output system 120, and in particular, LLM engine 141, may use the quantized LLM, e.g., in place of the original unquantized LLM, to process NL input and perform a variety of different predictions.

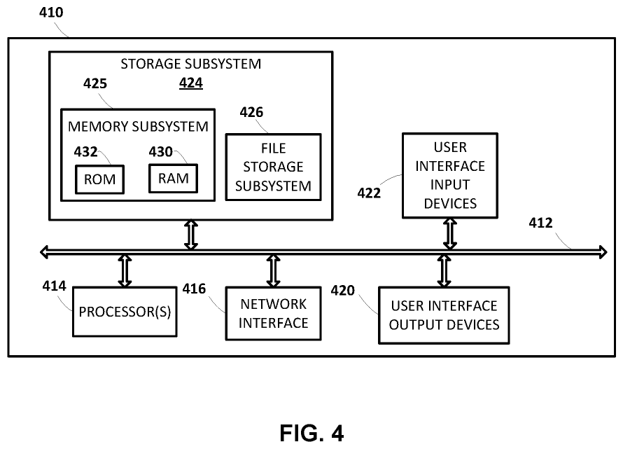

Turning now to FIG. 4, a block diagram of an example computing device 410 that may optionally be utilized to perform one or more aspects of techniques described herein is depicted. In some implementations, one or more of a client device, cloud-based automated assistant component(s) or other cloud-based software application component(s), and/or other component(s) may comprise one or more components of the example computing device 410.

Computing device 410 typically includes at least one processor 414 which communicates with a number of peripheral devices via bus subsystem 412. These peripheral devices may include a storage subsystem 424, including, for example, a memory subsystem 425 and a file storage subsystem 426, user interface output devices 420, user interface input devices 422, and a network interface subsystem 416. The input and output devices allow user interaction with computing device 410. Network interface subsystem 416 provides an interface to outside networks and is coupled to corresponding interface devices in other computing devices.

User interface input devices 422 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 410 to the user or to another machine or computing device.

Storage subsystem 424 stores programming and data constructs that provide the functionality of some or all of the modules described herein. For example, the storage subsystem 424 may include the logic to perform selected aspects of the methods disclosed herein, as well as to implement various components depicted in FIG. 1.

These software modules are generally executed by processor 414 alone or in combination with other processors. Memory 425 used in the storage subsystem 424 can include a number of memories including a main random-access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computing device 410 communicate with each other as intended. Although bus subsystem 412 is shown schematically as a single bus, alternative implementations of the bus subsystem 412 may use multiple busses.

Computing device 410 can be of varying types including a workstation, server, computing cluster, blade server, server farm, or any other data processing system or computing device. Due to the ever-changing nature of computers and networks, the description of computing device 410 depicted in FIG. 4 is intended only as a specific example for purposes of illustrating some implementations. Many other configurations of computing device 410 are possible having more or fewer components than the computing device depicted in FIG. 4.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
obtaining a trained large language model (LLM), wherein the trained LLM includes a plurality of layers, each layer comprising a respective plurality of weights;
for each layer of the plurality of layers:
calculating an optimal clipping range for the respective plurality of weights, and
clipping one or more weights of the respective plurality of weights that lie outside of the optimal clipping range to produce a clipped layer;
quantizing the LLM to generate a quantized LLM, wherein the quantizing includes mapping weights of the plurality of clipped layers of the LLM from continuous values to discrete values; and
providing the quantized LLM for downstream processing.

2. The method of claim 1, wherein the calculating is performed using greedy search.

3. The method of claim 1, wherein the optimal clipping range is calculated based on a max-absolute-error.

4. The method of claim 1, wherein the optimal clipping range is calculated to balance resolution errors and clipping errors of the LLM.

5. The method of claim 1, wherein the LLM comprises a transformer model.

6. The method of claim 1, wherein the quantizing comprises asymmetric weight quantization.

7. The method of claim 6, wherein the asymmetric quantization includes pre-calculation of a zero point.

8. A system comprising one or more processors and memory storing instructions that, in response to execution by the one or more processors, cause the one or more processors to:
obtain a trained large language model (LLM), wherein the trained LLM includes a plurality of layers, each layer comprising a respective plurality of weights;
for each layer of the plurality of layers:
calculate an optimal clipping range for the respective plurality of weights, and
clip one or more weights of the respective plurality of weights that lie outside of the optimal clipping range to produce a clipped layer;
quantize the LLM to generate a quantized LLM, wherein the instructions to quantize include instructions to map weights of the plurality of clipped layers of the LLM from continuous values to discrete values; and
provide the quantized LLM for downstream processing.

9. The system of claim 8, wherein the calculating is performed using greedy search.

10. The system of claim 8, wherein the optimal clipping range is calculated based on a max-absolute-error.

11. The system of claim 8, wherein the optimal clipping range is calculated to balance resolution errors and clipping errors of the LLM.

12. The system of claim 8, wherein the LLM comprises a transformer model.

13. The system of claim 8, wherein the quantizing comprises asymmetric weight quantization.

14. The system of claim 13, wherein the asymmetric quantization includes pre-calculation of a zero point.

15. At least one non-transitory computer-readable medium comprising instructions configured to cause one or more processors to:
obtain a trained large language model (LLM), wherein the trained LLM includes a plurality of layers, each layer comprising a respective plurality of weights;
for each layer of the plurality of layers:
calculate an optimal clipping range for the respective plurality of weights, and
clip one or more weights of the respective plurality of weights that lie outside of the optimal clipping range to produce a clipped layer;
quantize the LLM to generate a quantized LLM, wherein the instructions to quantize include instructions to map weights of the plurality of clipped layers of the LLM from continuous values to discrete values; and
provide the quantized LLM for downstream processing.

16. The at least one non-transitory computer-readable medium of claim 15, wherein the calculating is performed using greedy search.

17. The at least one non-transitory computer-readable medium of claim 15, wherein the optimal clipping range is calculated based on a max-absolute-error.

18. The at least one non-transitory computer-readable medium of claim 15, wherein the optimal clipping range is calculated to balance resolution errors and clipping errors of the LLM.

19. The at least one non-transitory computer-readable medium of claim 15, wherein the LLM comprises a transformer model.

20. The at least one non-transitory computer-readable medium of claim 15, wherein the quantizing comprises asymmetric weight quantization, and the asymmetric quantization includes pre-calculation of a zero point.
